(19) United States
(12) Patent Application Publication
(10) Pub. No.: US 2006/0069867 A1
(43) Pub. Date: Mar. 30, 2006

(54) Storage concept

(75) Inventors: Wolfgang Arndt, Langenfeld (DE); Joachim Bochmann, Duisburg (DE); Frank Scheler, Langenfeld (DE)

Correspondence Address: NORRIS, MCLAUGHLIN & MARCUS, 875 THIRD AVE, 18TH FLOOR, NEW YORK, NY, 10022, US

(73) Assignee: Bayer Business Services GmbH, Leverkusen (DE)

(21) Appl. No.: 11/233,641

(22) Filed: Sep. 23, 2005

(30) Foreign Application Priority Data
Sep. 29, 2004 (DE) 10 2004 04 7145.2

(51) Int. Cl. G06F 12/00

(52) U.S. Cl. 711/114

(57) ABSTRACT

The present invention relates to a device as well as a method for the saving or storage of data on physically different storage devices. By distributing the data to physically different storage devices, the deletion or removal of specific data is simplified. In addition, the specific storage and protection of data, for example depending on its relevance, is thus made possible. In addition, under data security aspects exists the advantageous option to store data sets differently such that that it is impossible at all times that physical data sets are present in a storage device, which may not actually be accessed without authorization, such that data can also be securely transferred in this respect. Furthermore, for the devices and the method according to the invention, no complicated aids are required to ensure the complete, i.e. outright physical deletion of all data. Alongside the advantages listed above, the performance of the device can be increased by means of the embodiment according to the invention, i.e. by means of the distribution of the data on multiple storage devices, i.e. the response times shortened and the availability of data increased.

### BACKGROUDN OD THE INVENTION

The present invention relates to a device as well as a method for the saving or storage of data on physically different storage devices.

With known devices for the storage of data, it has proven to be a disadvantage that the data that were created or processed in each case were not able to be stored on different physical storage devices, i.e. spatially separate storage locations, depending on predetermined criteria, for example. With the known devices, the targeted physical erasure of the data sets, depending on this criterion for example, proves to be very difficult or is not possible at all.

In addition, it is currently possible only at great expense to distribute data matched to relevance to different storage devices depending on its relevance in order to configure protection against unauthorized access to the data or protection against external effects such as fire or water. Furthermore, the option does not currently exist to save data sets differently such that it is ensured that no physical data sets are present on one storage device, which may not actually be accessed without authorization.

Such problems are partially solved by creating, processing, managing and saving the data separately. This is disadvantageous in that these procedures must be administered separately. Furthermore, data must be exchanged between the individual databases, frequently even by means of conversion and migration, which is time- and cost-intensive. This is particularly disadvantageous because this exchange cannot take place in real time, and additional security risks are associated with it.

Against the background of the disadvantages described above, the object of the present invention is to create a device as well an associated method that achieves a simplified, improved, secure memory storage and/or deletion of data.

This object is achieved by means of a generic device with the features of claim 1. Advantageous embodiments result from the subclaims. An advantageous method as well as an advantageous data medium result from the equivalent claims.

### BRIEF SUMMARY OF THE INVENTION

The device according to the invention has multiple devices that are physically separated from one another for the storage of data. In the sense of the invention, “physically separated” is to be thereby understood as meaning that the respective storage device is spatially separated such that the data stored there can be separated. For example, multiple hard disks are specified, which are controlled by a shared controller, but the individual hard disks can be removed. Furthermore, multiple servers can be specified in order to store and to manage the data in different, spatially separated locations. Different concepts are suitable as storage media: tape drives, hard drives, optical drives and so forth. The embodiment and selection of the storage technology is based, for example, on how great the spatial separation between the storage devices must be, what data throughput should be achieved during reading or writing, and whether and to what extent the media should be interchangeable.

In addition, a device for the storage of data on the physically different storage devices is specified. For example, a control is specified, which distributed the data sets to different storage devices on the basis of the description or content. For example, data sets involve individual attributes in a data field or in a table, or they involve entire documents. For example, the different physical storage devices are assigned to different logical drives by the operating system in order to simplify distribution and to increase clarity. For example, the devices are distributed to various computers, and a distribution of the data can take place, among other things, by means of known network protocols such as TCP/IP, and network devices such as switches, hubs and similar items.

For example, the data involves information coupled to a commercial process such as calendar data, sales number, as well as correspondence and writings associated with it, which is assigned to each individual process and stored in a recallable manner.

The deletion or destruction of specific data is simplified through the distribution of the data on physically different storage devices. Furthermore, with the devices according to the invention, no expensive aids are necessary to ensure the complete, i.e. outright physical deletion of all data. In addition, the specific storage and protection of data, for example depending on its relevance, is thus made possible. In addition, under data security aspects exists the advantageous option that it is impossible at all times that physical data sets are present at a storage location, which may not actually be accessed without authorization, such that data can also be securely transferred in this respect. Alongside the advantages listed above, the performance of the device can be increased by means of the embodiment according to the invention, i.e. by means of the distribution of the data on multiple storage devices, i.e. the response times shortened and the availability of data increased.

### DETAILED DESCRIPTION OF THE INVENTION

With the embodiment according to the invention, the criterion for the storage of the data sets on different physical storage devices can be multifaceted. The criterion can be a period of time, for example. Thus it can be ensured that sales figures, writings, or entire records that accumulate or were created or processed in a particular period of time, are stored separately for the particular period. If the legal storage obligation for such data expires, for example, all of the data falling thereunder can be deleted very easily by deletion and destruction of the physical storage device, for example of the associated data medium.

A further advantageous embodiment specifies differently designed storage devices. For example, the specific storage device can be designed differently with respect to data security or protection against external effects such as fire or water. A qualitative gradation that stands in relation to the different storage devices is thus associated with the storage. For example, the data can be distributed to the different storage devices depending on its relevance, in order to configure protection against unauthorized access or against external effects such as fire or water, matched to relevance. For example, the relevance is evaluated on the basis of the user working on the data set and the user rights associated with him or her, or the data set is analysed, in order to determine the relevance and to appropriately store the data set on a targeted storage device.

In a further advantageous embodiment, means for the creation of data, in particular through processing of available data, are specified. For example, this involves a database. The system according to the invention is particularly advantageous in combination with a database, because even there the data result to be stored is particularly large. Further means can be specified alongside the database, which access the data files of the database.

A further advantageous embodiment specifies that the means for the creation of data and/or the device for the storage of data is designed such that the data exists in at least one table. For example, relational databases are used for this purpose, which support the relational view of data, i.e. both the table view (flat file) and the relational language as well as relational data integrity. These are particularly suitable for the implementation of the device according to the invention, because they are highly scalable, among other things.

According to a further advantageous embodiment, the means for the creation of data include SQL (Structured Query Language). It has a comparatively simple syntax and makes available a series of commands for the definition of data structures according to relational algebra for the manipulation of databases (adding, processing and deleting data sets) and for querying data. Through its role as a quasi-standard, SQL is of great importance, because independence can be achieved to a large extent.

In a further advantageous embodiment, the device for the storage of the data is designed such that the distribution of the data corresponds to the user structure, in particular to the association with a company unit.

If the device is used in a company, for example, the data can be stored in different physical storage locations depending on the organisational structure of the company to which the user belongs, such as subsidiary company, divisions, company groups, collaborating companies, and so forth. If, for example, a data set is created by a user who belongs to a company unit, it is stored on the storage device belonging to this company unit by means of the user's association with the company unit, whereby the information about the user is determined with his authentication, for example.

Thus on the one hand the storage of the data is particularly secure, and on the other hand data exchange is simplified by using a consistent means that spans the company for the creation of data. If only a single means is used for the creation of data, the administration of the device is also simplified. In addition, it is ensured that only data for the respective organisational structure are provided to the recipient, for example a regulatory authority, when data from a storage device or from associated data media is transferred.

In a further advantageous embodiment, the means for the creation of the data and/or the device for the storage of the data include at least one data field for an attribute associated with the data. For example, an attribute is provided in a table, which makes it possible to draw inferences about the storage device to be selected for the table or from the criteria mentioned above, for example the association of the table with a company unit.

The device for the storage of the data and/or the means for the creation of data are designed in an advantageous embodiment such that the distribution is carried out on the basis of a specific designation from the table or data within which the data are stored. In this manner it is thereby accomplished that, upon the search for an individual data set, the complete tables or files need not be searched through with access to the data files, but instead the search can be reduced in scope through screening in advance.

In a further advantageous embodiment, the means for the creation of data and/or the device for their storage are designed in such a manner that the data are physically divided into data groups. This involves multiple files or tables, for example. It is thereby achieved that the data are more easily managed. For example, a file is stored for the specific data that are changing and that are to be managed in the database, for example the data for a company unit.

In a further advantageous embodiment, the tables are logically summarised. At the same time, a logical memory unit is involved. The memory can thus be managed independently from the means of data creation, for example a database. The data that are reserved for the database are thus stored in a manner analogous to a partition on a hard drive. A logical storage device of this type is implemented by means of one or more files of fixed size at the level of the operating system. The management of this logical storage device takes place, for example, through the database or a database management program, and access by the operating system is largely avoided, which is associated with an increase in security and speed.

Various logical storage devices are specified in an embodiment, depending on the number of the characteristics of the criteria, for example the number of company units. Separate data files with an associated storage device are defined for each logical storage device, which are activated by means of logical mapping information, for example. At the same time, the logical mapping information can relate both to the same or different physical storage devices.

In a further advantageous embodiment, the means for the creation of data and/or the device for storage are designed such that the table is partitioned. At the same time, it involves an organisational form for the individual table that particularly benefits from spatially distributed databases. A data set is thus distributed to multiple spatially distributed partitions of the individual table, which can be separately managed under the control of an individual database management program. From the point of view of the application accessing the database, all data can be read and written via the names of the partition tables. The indices belonging to a partition table can likewise be partitioned—based on discrete criteria or criteria identical to the table itself.

The partition criteria are attribute specifications for attributes within the defined table, for example. This attribute specification is used in an embodiment for the purpose of accessing the table of an individual logical device with associated data files. Thus the data for each company unit, for example, can be stored in different logical devices as a criterion for sorting the data.

In a further advantageous embodiment, at least one physically different storage device includes a removable data medium. For example, this involves a magnetic tape drive or an optical or magneto-optical drive. The data medium can thus be easily removed, kept or destroyed if necessary.

According to a further advantageous embodiment, the data include information about commercial intellectual property rights. In particular, the data that are associated with commercial intellectual property rights can be particularly sensitive under data security aspects such that the use of the system according to the invention in this area is particularly advantageous. Thus, for example, if an intellectual property right is administered by the company as an applicant, then the data set is stored specifically on the storage device belonging to the company unit with the advantages initially mentioned, such as simplified deletion, secure transfer, and so forth.

The invention further relates to a method using a system in the embodiment described above, whereby the data are stored on at least one of the physically different storage devices. At the same time, the physically different storage devices can lie on different storage systems. The storage systems can control controllers of different technology at the same time. The criterion by which the data are arrived at through the means of the storage of the data on different storage devices can be specified by a time period, in which the creation or processing of an associated data set takes place, or by the user who creates or processes the data, without being limited to these two examples.

The protection of data depending on its relevance is made possible by means of specific storage, in order to load them, for example, from differently secured storage devices. In addition, under data security aspects exists the advantageous possibility of storing data sets differently such that it is impossible at all times that physical data sets are present at a storage location, which may not actually be accessed without authorization, such that data can also be securely transferred in this respect. Alongside the advantages listed above, the performance of the device can be increased by means of the embodiment according to the invention, i.e. by means of the distribution of the data on multiple storage devices, i.e. the response times shortened and the availability of data increased.

The data that were distributed to the storage devices are deleted from a storage device in a further advantageous embodiment. The data can thereby be destroyed quite simply, without having to select data directed at a storage device in advance. Thus the physical deletion and destruction of the selected data, for example after the expiration of a legal storage obligation, turns out to be particularly simple and secure. Reconstruction of the data is no longer possible. In fact, most operating systems do provide a deletion process, but most do not physically delete the data, but rather merely eliminate the administrative data sets provided by the operating system, on the basis of which the operating system retrieves the physical storage location. Complex and expensive aids are required to be able to perform a physical deletion on traditional devices.

The invention further pertains to a data medium, such as CDs and similar items, on which the method described previously is carried out and which produces the advantages described previously.

1. A computer device comprising a controller and a plurality of storage devices for data, mechanisms wherein the data are selectively stored in one of the plurality of storage devices, and wherein the plurality of data storage devices are physically separate from one another.

2. The computer device according to claim 1, wherein the data storage devices comprise one of tape drive, hard drive or optical drive.

3. The computer device according to claim 1, further comprising means for the creating data by processing existing data.

4. The computer device according to claim 1, wherein the means for the creating data and/or the-data storage is designed such that the data exist in at least one table.

5. The computer device according to claim 3, whereby the means for the creation of data include the SQL language.

6. The computer device according to claim 1, wherein the data storage is designed such that the distribution of the data corresponds to a user structure.

7. The computer device according to claim 1, wherein the means for the creation of the data and/or the data storage include at least one data field for an attribute associated with the data.

8. The computer device according claim 3, wherein the means for data and/or data storage of the data are designed such that a distribution is carried out based on a specific identifier for the file or the at least one table.

9. The computer device according to claim 3, wherein the means creating data and/or the data storage are designed such that the data are physically broken down into data groups.

10. The computer device according to claim 3, wherein the means for creating data and/or the data storage is designed such that the tables are logically summarized.

11. The computer device according to claim 3, wherein the means for creating data and/or the data storage is designed such that the table is partitioned.

12. The computer device according to claim 3, wherein at least one of the plurality of physically different storage devices includes a removable data medium.

13. The computer device according to claim 1, wherein the data includes information about commercial intellectual property rights.

14. (canceled)

15. (canceled)

16. (canceled)

17. A method of using a computer device comprising the steps of providing a controller and a plurality of storage devices for data;
physically separating the plurality of data storage devices from one another;
selectively storing data in one of the plurality of storage devices;
providing a mean for data processing.

18. The method of using the computer device, further comprising the step of means for deleting or removing data from at least one of the plurality of storage devices.
